(19) United States
(12) Patent Application Publication
(10) Pub. No.: US 2026/0308955 A1
(43) Pub. Date: Oct. 8, 2026

(54) DRIVING-BAR DEVICE, LOCKING APPARATUS AND SASH ARRANGEMENT

(71) Applicant: Gretsch-Unitas GmbH Baubeschläge, Ditzingen (DE)

(72) Inventor: Clive Markovic, Gerlingen (DE)

(21) Appl. No.: 19/481,643

(22) PCT Filed: May 7, 2024
(86) PCT No.: PCT/EP2024/062644

§ 371 Date: Nov. 5, 2025

(30) Foreign Application Priority Data
May 9, 2023 (DE) 10 2023 112 069.7

(51) Int. Cl. E05C 1/06; E05C 1/00; E05C 7/04

(52) U.S. Cl. CPC E05C 1/06; E05C 1/006; E05C 7/045

(57) ABSTRACT

A driving-bar device for actuating a locking device is disclosed. The driving-bar device is insertable into a driving-bar channel of a sash arrangement and includes a driving bar and at least one centering element configured to center the driving bar within the channel. The centering element is configured to be fixed to the driving bar, for example by rotational or locking engagement, to maintain alignment during operation. A locking apparatus incorporating the driving-bar device and a sash arrangement including the locking apparatus are also disclosed.

The invention relates to a driving-bar device for actuating a locking device, a locking apparatus and a sash arrangement.

Driving-bar devices are known from the prior art and are often used in conjunction with a locking device in a sash arrangement which as a whole are sometimes referred to as multi-point locking. Known sash arrangements typically comprise a frame that delimits an opening and a sash pivotally mounted on the frame. In a closed position, the sash closes the opening and, in an open position, releases the opening. A locking device is often provided on the sash to lock the sash to the frame in the closed position. Locking prevents an accidental transfer of the sash from the closed position to the open position.

In order to actuate the locking device and therefore to lock or release the sash on the frame, an actuating device can be provided on the sash which is actuated by a user. The actuating device can comprise a handle (e.g., a door handle). Often a distance must be overcome between the locking device and the actuating device, in particular if the locking device is arranged in an upper or lower sash region of the sash, and the actuating device is arranged in the middle of the sash. For this purpose, driving-bar devices are typically used which bridge the distance and actuate the locking device depending on the actuation of the actuating device.

A driving-bar device is inserted into a driving-bar channel of the sash, in particular if a concealed arrangement is desired. The driving-bar channel can be designed as a circumferentially closed channel within the sash. The driving-bar channel often extends from a receptacle for the actuating device to a receptacle for the locking device. In order to enable the driving-bar device to be inserted into the driving-bar channel, the cross section of the driving-bar channel is usually larger than the cross section of the driving-bar device. As a result, a driving-bar device inserted in the driving-bar channel can advantageously be moved particularly easily in a longitudinal direction of the driving-bar channel.

In order to couple the driving-bar device inserted into the driving-bar channel to the actuating device, the actuating device can have a driving-bar coupling element that can be reversibly or detachably coupled to a corresponding coupling element of the driving-bar device. The coupling element is usually arranged at one end of the driving-bar device. At an end of the driving-bar device opposite the coupling element, the driving-bar device can be designed so that it can be coupled to the locking device. The locking device can comprise a pin, a latch or a latch device. Alternatively, an element of the driving-bar device and the locking device can be designed as a single piece. For example, the driving-bar device can comprise a driving bar in which a pin is arranged at the end opposite the coupling element, wherein the pin and driving bar are designed as one piece.

By actuating the locking device by means of the driving-bar device, the locking device can be displaced in such a way that the locking device engages in a recess on or in the frame and thereby locks the sash in the closed position to the frame, or that the locking device does not engage in the recess in the frame and thereby releases the sash.

It is an object of the present invention to provide a driving-bar device which has improved properties, in particular which facilitates assembly and is more reliable in its operation. It is a further object of the present invention to provide a locking apparatus and a sash arrangement that each have such a driving-bar device.

The invention achieves these objects by the features of claim 1, claim 14 and claim 15. Advantageous embodiments and developments of the invention emerge from the dependent claims.

A driving-bar device according to the invention is designed and/or intended for actuating a locking device, wherein the driving-bar device can be inserted into a driving-bar channel of a sash arrangement. The driving-bar device has a driving bar and at least one centering element for centering the driving bar within the driving-bar channel, i.e., relative to the walls delimiting the driving-bar channel. The centering element can be fixed or is fixed to the driving bar.

Advantageously, the centering element is designed to position the driving bar within the driving-bar channel in such a way that the driving bar is aligned relative to an actuating device so that no correction of the alignment of the driving bar is required when establishing a coupling between the driving bar and the actuating device. This makes it easier to establish a coupling between the driving bar and the actuating device. In particular, the coupling can be established at the same time as the driving bar is inserted into the driving-bar channel. The driving-bar device therefore makes assembly easier.

Furthermore, the centering element advantageously achieves a local thickening of the driving bar, which limits bending of the driving-bar as a result of axial compressive stress during actuation in such a way that buckling of the driving bar is prevented or at least greatly reduced. This makes the driving-bar device particularly reliable in its operation.

The driving-bar channel can have a rectangular or round cross section.

The centering element can be inserted into the driving-bar channel together with the driving bar. The centering element can be fixed to the driving bar before inserting the driving-bar device into the driving-bar channel (the centering element is fixed to the driving bar before being inserted).

The driving bar extends along a central longitudinal axis. The driving bar can have a rectangular or round cross section. In the case of a rectangular cross section, the driving bar can have two flat sides (“width of the driving bar”) and two narrow sides (“thickness of the driving bar”). One, two, three or four centering elements can be fixable or fixed to the driving bar.

The driving bar can have a coupling element at one end for coupling to a corresponding driving-bar coupling element of an actuating device. At an end of the driving bar opposite the coupling element, the driving bar can be connectable to a locking device. Alternatively, the driving bar and the locking device can be designed as a single piece. In particular, the locking device, for example in the form of a pin, can be arranged on the driving bar at the end opposite the coupling element (latch side), wherein the locking device and the driving bar are designed as one piece.

The centering element and the driving bar can be designed as separate components. The centering element and the driving bar can be made of the same or different materials. For example, the driving bar can be made of metal.

In a further development of the driving-bar device, the centering element can be positioned in a positioning position on or along the driving bar and can be fixed to the driving-bar in a fixing position (relative to the driving bar) different from the positioning position. The centering element can be transferred or displaced between the positioning position and the fixing position. In the positioning position, the centering element can be positioned at any position along the driving bar. The centering element can be moved into the fixing position after positioning on the driving bar. For example, the centering element can be displaceable in the positioning position, in particular only along or parallel to a longitudinal axis of the driving bar. In the positioning position and in the fixing position, the centering element can surround the driving bar to the outside, e.g., radially. The centering element can have a passage, wherein in the positioning position, the driving bar is inserted into the passage.

The centering element can be designed such that a transfer or displacement of the centering element between the positioning position and the fixing position takes place by rotating or pivoting the centering element about a pivot axis, wherein the pivot axis is oriented orthogonally to the central longitudinal axis of the driving bar. Preferably, the pivot axis can be oriented orthogonally to a flat side of the driving bar.

In a further development of the driving-bar device, the centering element can be fixed to the driving bar by rotating or pivoting about a pivot axis by an angle of 25° to 90°, in particular 30° to 60°, 30° to 40° or 35°. Advantageously, the rotation can be done without additional tools. This allows the centering element to be fixed to the driving bar without additional tools, which simplifies the fixing of the centering element to the driving bar. The rotation of the centering element can occur relative to the driving bar, e.g., relative to a flat side of the driving-bar. The centering element can be moved from the positioning position to the fixing position by rotating or pivoting relative to the driving bar, in particular by the angles mentioned above. The centering element can be moved from the fixing position to the positioning position by rotating opposite the direction of rotation or pivoting opposite the direction of rotation.

In a further development of the driving-bar device, the centering element can be fixed or secured to the driving bar by means of a form-fitting, force-locking and/or integral connection. In the fixing position, the centering element and the driving bar can have a form-fitting, force-locking and/or integral connection. The force-locking connection can be a clamp connection. The centering element can be U-shaped and can be fixed to the driving-bar by means of a clamping connection, wherein in particular in the fixing position, the driving bar is encompassed by the U-shaped centering element. The integral connection can be provided alone or to support another type of connection.

In a further development of the driving-bar device, the centering element can have a first locking element to provide a form-fitting connection. The driving bar can have a second locking element corresponding to, preferably complementary to, the first locking element. The centering element can be or is fixed to the driving bar by means of a locking connection formed by the first locking element and the second locking element.

In a further development of the driving-bar device, the first locking element can have a locking lug and the second locking element can have a locking opening. It is also conceivable that the first locking element is designed as a locking lug and the second locking element as a locking opening. The locking opening can be a recess, in particular a passage.

In a further development of the driving-bar device, the centering element can have at least one (outwardly facing) sliding surface. “Outwardly facing” means that the sliding surfaces face away from the driving bar when the centering element is mounted on the driving bar. The at least one sliding surface is designed to slide along a wall of the driving-bar channel. The sliding surface can slide along the wall when the driving-bar device is inserted into the driving-bar channel and when the locking device is actuated. The centering element can have two opposing sliding surfaces, that are each designed to slide along one of two opposite walls of the driving-bar channel.

In a further development of the driving-bar device, the sliding surface can be flat or convex, in particular uniaxially convex. Advantageously, the convex shape of the sliding surface simplifies the insertion of the driving-bar device into the driving-bar channel. If the centering element has several sliding surfaces, at least one of the sliding surfaces can be flat or convex.

In a further development of the driving-bar device, the centering element can be designed point-symmetrically in a longitudinal section. Alternatively, the centering element can be designed point-symmetrically to a center of gravity of the centering element. Advantageously, the point symmetry simplifies the production of the centering element. Due to the point symmetry, the centering element can be fixed to the driving bar independently of a preferred direction. This simplifies assembly.

In a further development of the driving-bar device, the centering element is made of a plastic material, in particular of one of the copolymers polyoxymethylene (POMC) or polyamide 6(PA6 ). The plastic material can be insensitive to moisture.

In a further development of the driving-bar device, the centering element can have a receiving space. The driving bar is arranged within the receiving space when the centering element is fixed to the driving bar. In the fixing position and/or in the positioning position, the driving bar can be arranged within the receiving space.

In a further development of the driving-bar device, the receiving space can have a closed circumference. The closed circumference can prevent the driving bar from accidentally or laterally leaving the receiving space, in particular when the centering element is moved along a longitudinal axis of the driving bar.

In a further development of the driving-bar device, the receiving space can have two opposite openings for arranging the driving bar within the receiving space. Each opening has a first opening portion and a second opening portion. The driving bar is arranged within the first opening sections for positioning the centering element on the driving bar. The driving bar is arranged within the second opening sections when the centering element is fixed to the driving-bar. Each opening can be arranged on an end face of the centering element. Each opening can extend from the end face to ⅔ of a side surface of the centering element. A height of the first opening sections may differ from a height of the second opening sections. A ratio of the height of the second opening sections to the height of the first opening sections can be 0.5 to 0.75, in particular 0.55 to 0.7 or 0.6 to 0.65.

A locking apparatus according to the invention for a sash arrangement with a driving-bar channel has a previously described driving-bar device and a locking device which is coupled or connected to the driving-bar device. The driving bar can be coupled or connected to the locking device. In particular, one end of the driving bar can be coupled or connected to the locking device. For example, the locking device can comprise a latch that is coupled and connected to the end of the driving bar at one latch end of the latch. At another end of the driving bar, a coupling element can be provided for reversibly or detachably coupling the driving bar to an actuating device.

A sash arrangement according to the invention has a locking apparatus as described above, a frame and a sash with a driving-bar channel. The sash is held by the frame and pivotably mounted relative to the frame. The driving-bar device is arranged within the driving-bar channel. By actuating the locking device by means of the driving-bar device, the locking device can be displaced in such a way that the locking device engages in a recess in the frame and thereby locks the sash in the closed position to the frame, or that the locking device does not engage in the recess in the frame and thereby releases the sash. The sash may have a number of driving-bar channels, in particular 1 or 2 driving-bar channels. A previously described driving-bar device can be arranged in each of the driving-bar channels.

Further advantages and aspects of the invention emerge from the claims and from the following description of preferred exemplary embodiments of the invention, which are explained with reference to the figures. Identical and functionally equivalent elements are provided with identical reference signs, but possibly only once. In the drawings:

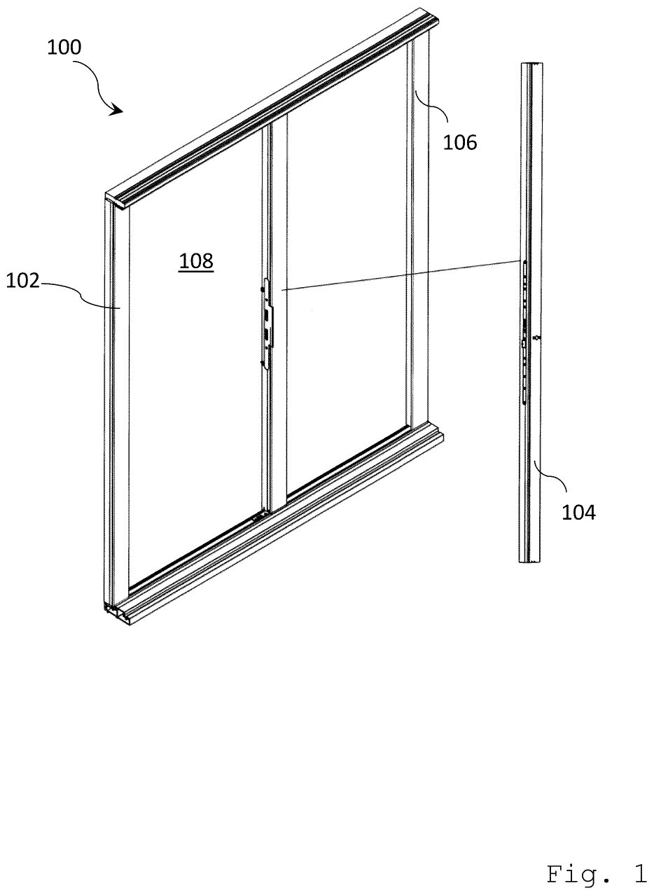

FIG. 1 is a schematic view of a sash arrangement with a frame, a first sash and a second sash,

FIG. 2 is a schematic sectional view of the first sash of FIG. 1 with a driving-bar channel and a driving-bar device to be inserted into the driving-bar channel,

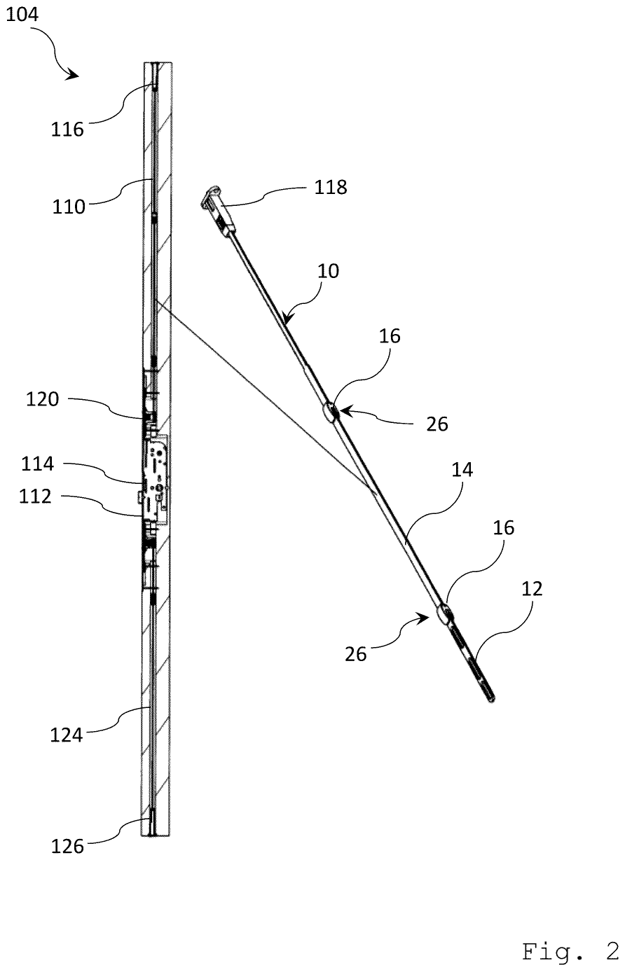

FIG. 3 is a schematic oblique view of a centering element of the driving-bar device of FIG. 2,

FIG. 4 is a further schematic oblique view of the centering element from FIG. 3.

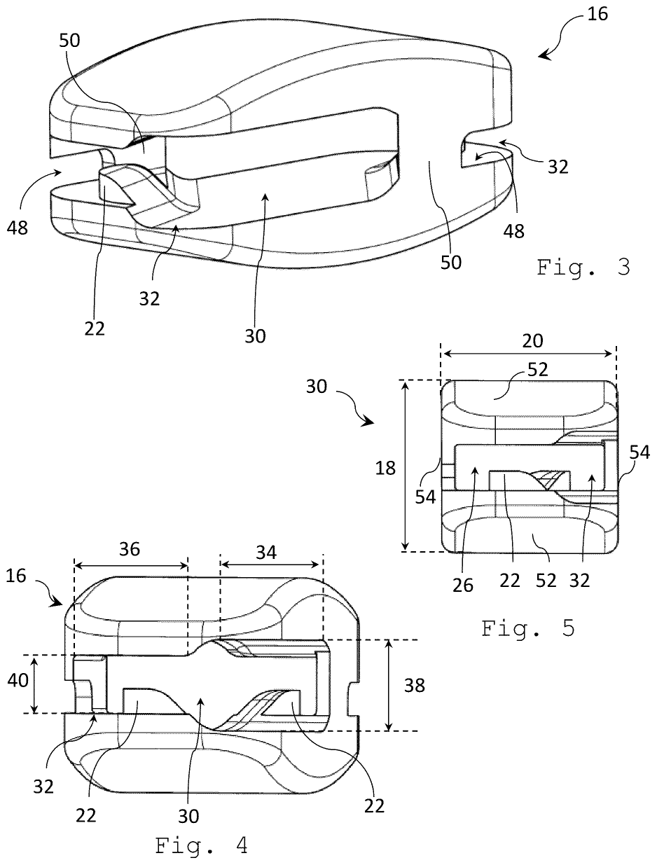

FIG. 5 is a schematic front view of the centering element from FIG. 3,

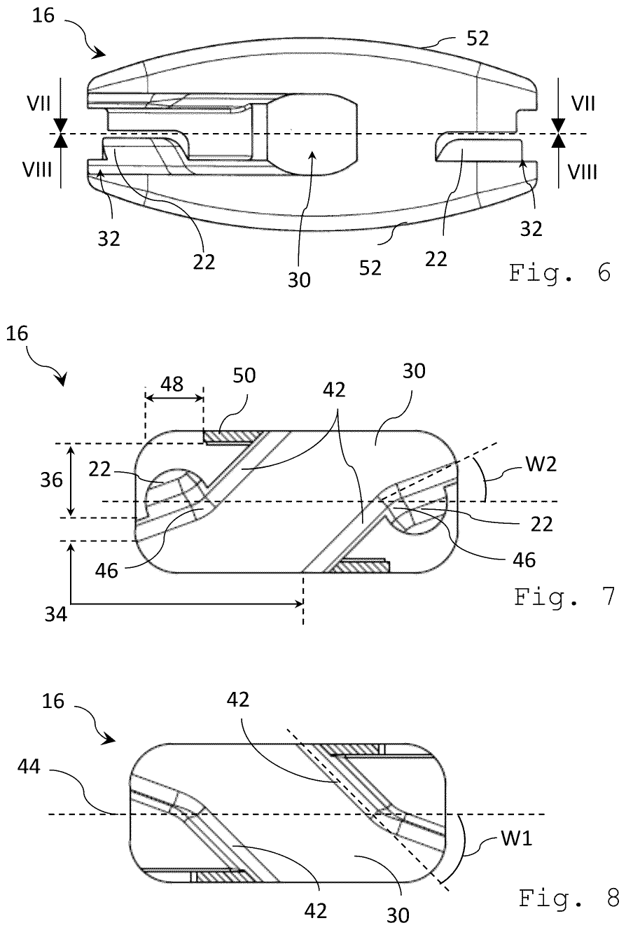

FIG. 6 is a schematic side view of the centering element from FIG. 3;

FIG. 7 is a schematic sectional view of the centering element along a section line VII-VII in accordance with FIG. 6,

FIG. 8 is a further schematic sectional view of the centering element along a section line VIII-VIII in accordance with FIG. 6,

FIG. 9 is a schematic oblique view of the driving-bar device of FIG. 2 during positioning of the centering element on a driving bar of the driving-bar device,

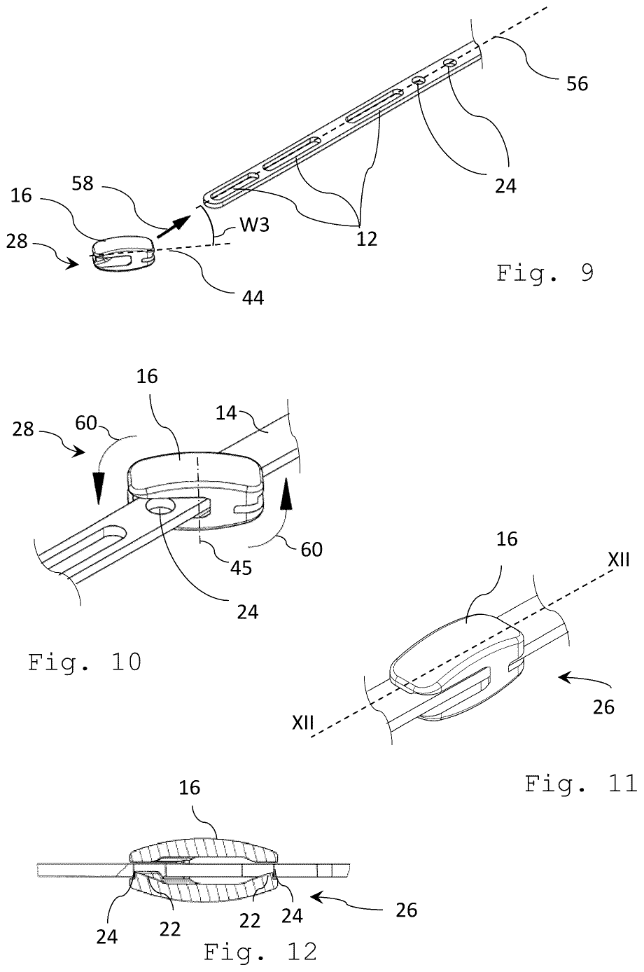

FIG. 10 is a schematic oblique view of the centering element and the driving bar of FIG. 9 when fixing the centering element to the driving bar,

FIG. 11 is a schematic oblique view of the centering element and the driving bar of FIG. 10, wherein the centering element is fixed to the driving-bar, and

FIG. 12 is a schematic sectional view of the centering element and the driving bar along a section line XII-XII in accordance with FIG. 11.

FIG. 1 shows a sash arrangement 100 with a frame 102, a first sash 104 and an optional second sash 106 which can alternatively be a fixed field (not shown). For reasons of clarity, the first sash 104 is only partially shown in FIG. 1 on the right.

The frame 102 defines an opening 108. The first sash 104 and the second sash 106 are each pivotally mounted on the frame 102. In a closed position of the first sash 104 and the second sash 106, the opening 108 is closed, and in an open position of the first sash 104 and the second sash 106, the opening 108 is released. FIG. 1 shows the closed position of the second sash 106.

FIG. 2 shows a section of the first sash 104. The first sash 104 has a driving-bar channel 110. The driving-bar channel 110 is a circumferentially closed channel within the first sash 104. The driving-bar channel 110 can also be called a concealed channel. In the example, the driving-bar channel 110 has a square cross section. The cross section of the driving-bar channel 110 can, for example, have the dimensions 15 mm×15 mm. The driving-bar channel 110 extends from a receptacle 112 for an actuating device 114 to a receptacle 116 for a locking device 118.

An actuating device 114 is already inserted in the receptacle 112 for the actuating device 114. The actuating device 114 can be actuated by a user by pressing a handle (not shown), e.g. a door handle.

The locking device 118, which is yet to be inserted into the receptacle 116, is provided to lock the first sash 104 in the closed position on the frame 102. The locking device 118 is shown on the right in FIG. 2. The locking device 118 to be inserted into the receptacle 116 is connected to a driving-bar device 10 to be inserted into the driving-bar channel 110. In the example, the insertion of the locking device 118 into the receptacle 116 and the insertion of the driving-bar device 10 into the driving-bar channel 110 take place simultaneously.

In order to couple the driving-bar device 10 to be inserted into the driving-bar channel 110 with the actuating device 114, the actuating device 114 has a driving-bar coupling element 120 which can be reversibly or detachably coupled to a corresponding coupling element 12 of the driving-bar device 10. The coupling element 12 is arranged at an end of the driving-bar device 10 opposite the locking device 118. The coupling element 12 is designed as an elongated hole, see also FIG. 9. The driving-bar coupling element 120 of the actuating device 114 has a latch which engages in the elongated hole in a coupled state. The coupling of the driving-bar device 10 with the actuating device 114 takes place simultaneously with the insertion of the driving-bar device 10 into the driving-bar channel 110.

In the shown embodiment, the driving-bar device 10 has a plurality of coupling elements 12. A total of three elongated holes is provided, wherein the driving-bar coupling element 120 is coupled to one of the three elongated holes. Depending on a length of the driving-bar channel 110, the driving-bar coupling element 120 is coupled to one of the coupling elements 12. In alternative embodiments, more or fewer than three elongated holes may be provided.

When the locking device 118 is inserted into the receptacle 116 and the driving-bar device 10 is inserted into the driving-bar channel 110, a distance between the actuating device 114 arranged in a center of the first sash 104 and the locking device 118 arranged in an upper sash region of the first sash 104 is bridged by means of the driving-bar device 10.

If the driving-bar device 10 is coupled to the actuating device 114, the locking device 118 is displaced by means of the driving-bar device 10 by actuating the actuating device 114. In particular, the locking device 118 has a latch which is displaced between a locked position and an unlocked position when the actuating device 114 is actuated by means of the driving-bar device 10. In the closed position of the first sash 104, the first sash 104 is locked to the frame 102 by moving the latch into the locked position. The latch engages in a recess on the frame 102. If the latch is transferred into the unlocked position, the latch does not engage in the recess, and the sash 104 is released.

FIG. 2 shows that the previously described driving-bar device 10 and locking device 118 are to be inserted into the upper half of the first sash 104. The first sash 104 has in its lower half further driving-bar channel 124 and further receptacle 126. A further driving-bar device (not shown) and a further locking device (not shown) can be inserted into the further driving-bar channel 124 and into the further receptacle 126. The further driving-bar device and the further locking device can have the same or functionally identical features as the previously described driving-bar device 10 and locking device 118. By means of the two locking devices and the two driving-bar devices, the first sash 104 can be locked or released in the closed position upon actuation of the actuating device 114 in its lower half and simultaneously in its upper half on the frame 102.

The driving-bar device 10 comprises a driving bar 14. In the example, the driving bar 14 has a rectangular cross section with two flat sides (“width of the driving bar”) and two narrow sides (“thickness of the driving bar”) . The cross section of the driving bar 14 is smaller than the cross-section of the driving-bar channel 110. The cross section of the driving bar 14 can, for example, have the dimensions 4 mm×11 mm. The driving bar 14 is made of a metal, in particular steel.

Furthermore, the driving-bar device 10 comprises two centering elements 16 for centering the driving bar 14 within the driving-bar channel 110. The two centering elements 16 and the driving bar 14 are designed as separate components.

The two centering elements 16 are made of a copolymeric polyoxymethylene plastic material and are fixed to the driving bar 14. The centering elements 16 are fixed to the driving bar 14 before inserting the driving bar 14 into the driving-bar channel 110.

The two centering elements 16 have the same features, which is why one of the two centering elements 16 is described representatively below.

FIG. 3 to 8 each show one of the two centering elements 16 in different views.

The centering element 16 can, for example, have a height 18 of 14.5 mm and a width 20 of 14.5 mm, see FIG. 5. The centering element 16 positions the driving bar 14 within the driving-bar channel 110 during insertion such that the coupling element 12 is aligned relative to the driving bar coupling element 120 so that no correction of the alignment of the driving bar 14 is required to establish the coupling between the coupling element 12 and the driving-bar coupling element 120. This allows the coupling to take place simultaneously with the insertion of the driving bar 14 into the driving-bar channel 110.

The centering element 16 is fixed by means of a form-fitting connection between the driving bar 14 and the centering element 16. In the example, the form-fitting connection is a locking connection. For this purpose, the centering element 16 has a first locking element 22 in the form of two locking lugs. The driving bar 14 has a second locking element 24 corresponding to the first locking element 22 in the form of two passages. The two passages can each also be called a locking opening. In a locked state, the two locking lugs are engaged in the two passages. By means of this locking connection, the centering element 16 is fixed to the driving bar 14 (see, for example, FIG. 11 or 12).

When the centering element 16 is fixed to the driving bar 14, the centering element 16 is in a fixing position 26 (see FIGS. 2, 11 and 12). When the centering element 16 is not fixed to the driving bar 14, the centering element 16 is in a positioning position 28, see FIGS. 9 and 10. In the positioning position 28, the centering element 16 can be moved relative to the driving bar 14 or positioned along the driving bar 14. Transferring the centering element 16 between the fixing position 26 and the positioning position 28 can be achieved by rotating or pivoting the centering element 16 about a pivot axis, as explained above.

The centering element 16 has a receiving space 30 (see FIG. 3). The receiving space 30 is closed in its circumference. The receiving space 30 has two opposite openings 32 for arranging the driving bar 14 within the receiving space 30. In order to arrange the driving bar 14 within the receiving space 30, the driving bar 14 is inserted into both openings 32.

Each of the two openings 32 has a first opening section 34 and a second opening section 36 (see FIG. 4 in oblique view and FIG. 7 in sectional view). Each second opening section 36 is arranged, in particular only, on one end face of the centering element 16 or is adjacent thereto. Each first opening section 34 is arranged on the end face of the centering element 16 and on a side surface of the centering element 16 or is adjacent thereto. In the positioning position 28, the driving bar 14 is arranged within the first opening sections 34, and in the fixing position 26, the driving bar 14 is arranged within the second opening sections 36.

A height 38 of the first opening sections 34 differs from a height 40 of the second opening sections 36, see FIG. 4. A ratio of the height 40 of the second opening sections 36 to the height 38 of the first opening sections 34 can be, for example, 0.65. The height 40 of the second opening sections 36 corresponds to a thickness of the driving bar 14. In the illustrated embodiment, the height 40 of the second opening sections 36 is 4 mm.

The receiving space 30 is delimited by guide surfaces 42, in particular in a corner region of the receiving space 30 (see FIGS. 7 and 8). In the illustrated embodiment, the guide surfaces 42 are curved. In the illustrated embodiment, the centering element 16 has four guide surfaces 42, each of which is designed to guide the driving bar 14 when the driving bar is arranged within the first opening sections 34. The guide surfaces 42 extend with respect to a longitudinal axis 44 of the centering element 16 at an angle W1 of, for example, 45° (see FIG. 8). In alternative embodiments, the angle may have a different value.

The centering element 16 has two centering surfaces 46, each of which is arranged on one of the two locking lugs. The centering surfaces 46 extend with respect to the longitudinal axis 44 at an angle W2 of, for example, 30° (see FIGS. 7 and 8). In alternative embodiments, the angle may have a different value.

The centering surfaces 46 are adjacent to the guide surfaces 42. In other words: The centering surfaces 46 extend the guide surfaces 42. When the centering element 16 is transferred from the positioning position 28 into the fixing position 26, the driving bar 14 slides along the centering surfaces 46 until the fixing position 26 is reached. The centering surfaces 46 facilitate the transfer from the positioning position 28 to the fixing position 26.

The centering element 16 comprises two recesses 48 that are each provided on a side wall 50 of the centering element 16, see FIG. 3. Each recess 48 is arranged at one of the two openings 32. The two recesses 48 weaken the side walls 50 in such a way that the side walls 50 act as spring elements when the centering element 16 is transferred from the positioning position 28 into the fixing position 26. In other words: if the centering element 16 is transferred from the positioning position 28 into the fixing position 26, the side walls 50 are deformed until the first locking elements 22 reach the second locking elements 24 and engage in the second locking elements 24 while releasing the preload.

The centering element 16 has two sliding surfaces 52 that face away from each other and are designed to be uniaxially convex, and two opposite sliding surfaces 54 that are designed to be flat, see FIG. 5. The sliding surfaces 52, 54 are designed to slide along a wall of the driving-bar channel 110. In particular, the uniaxially convex sliding surfaces 52 reduce the contact surface between the centering element 16 and the wall of the driving-bar channel 110.

FIG. 9 to 12 show the individual steps for fixing the centering element 16 to a driving bar 14.

FIG. 9 shows the centering element 16 whose longitudinal axis 44 is rotated relative to the longitudinal axis 56 of the driving bar 14 by an angle W3 of 45° in the example. As a result, the centering element 16 is in the positioning position 28. The centering element 16 is placed on the driving bar 14. The placement is carried out by moving the centering element 16 in a plugging direction 58 which is parallel to the longitudinal axis 56 of the driving bar 14. As a result of being plugged on, the driving bar 14 is arranged within the first opening sections 34, and the driving bar 14 is radially surrounded by the centering element 16.

The centering element 16 is moved in the positioning position 28 parallel to the longitudinal axis 56 of the driving bar 14 until the centering element 16 reaches the second locking element 24 in the form of two passages. As a result, the centering element 16 is positioned on the driving bar 14 (see FIG. 10).

FIG. 10 shows the transfer of the centering element 16 from the positioning position 28 to the fixing position 26. For this purpose, the centering element 16 is rotated about a pivot axis 45 by an angle of 45° relative to the driving bar 14 in a direction of rotation 60. In the example, the pivot axis 45 is oriented orthogonally to a flat side of the driving bar 14 (“width of the driving bar”). During rotation, the first locking element 22 and the second locking element 24 engage with each other and form a form-fitting connection between the driving bar 14 and the centering element 16. By forming the locking connection, the centering element 16 is fixed to the driving bar 14, and the centering element 16 is in the fixing position 26 (see FIGS. 11 and 12).

No additional tools are required to fix the centering element 16 to the driving bar 14. Therefore, the centering element 16 simplifies the fixing to the driving bar 14.

As the shown and explained embodiments make clear, the invention provides a driving-bar device that facilitates assembly and is more reliable in its operation.

1-15. (canceled)

16. A driving-bar device for actuating a locking device, the driving-bar device being insertable into a driving-bar channel of a sash arrangement, the driving-bar device comprising a driving bar and at least one centering element configured to center the driving bar within the driving-bar channel, wherein the centering element is configured to be fixed to the driving bar.

17. The driving-bar device of claim 16, wherein the centering element is positionable in a positioning position along the driving bar and is fixable to the driving bar in a fixing position different from the positioning position.

18. The driving-bar device of claim 17, wherein the centering element is fixable to the driving bar by a rotation from about 25 degrees to about 90 degrees.

19. The driving-bar device of claim 18, wherein the centering element is fixed to the driving bar by form-fitting, force-locking, and/or integral connection.

20. The driving-bar device of claim 19, wherein the centering element includes a first locking element and the driving bar includes a second locking element complementary to the first locking element, the centering element being fixed to the driving bar by a locking connection formed by the first locking element and the second locking element.

21. The driving-bar device of claim 20, wherein the first locking element includes a locking lug and the second locking element includes a locking opening.

22. The driving-bar device of claim 21, wherein the centering element includes at least one sliding surface configured to slide along a wall of the driving-bar channel.

23. The driving-bar device of claim 22, wherein the sliding surface is flat or convex.

24. The driving-bar device of claim 23, wherein the centering element is formed point-symmetrically in a longitudinal section or point-symmetrically relative to a center of gravity of the centering element.

25. The driving-bar device of claim 24, wherein the centering element is formed from a plastic material.

26. The driving-bar device of claim 25, wherein the centering element defines a receiving space, and the driving bar is arranged within the receiving space when the centering element is fixed to the driving bar.

27. The driving-bar device of claim 26, wherein the receiving space has a closed circumference.

28. The driving-bar device of claim 27, wherein the receiving space includes two opposite openings, each defining a first opening section and a second opening section, the driving bar being arranged within the first opening sections for positioning the centering element on the driving bar and being arranged within the second opening sections when the centering element is fixed to the driving bar.

29. A locking apparatus for a sash arrangement having a driving-bar channel, the locking apparatus comprising a driving-bar device according to claim 28 and a locking device coupled to the driving-bar device.

30. A sash arrangement comprising a locking apparatus according to claim 29, a frame, and a sash having a driving-bar channel, wherein the sash is held by the frame and pivotally mounted relative to the frame, and wherein the driving-bar device is arranged within the driving-bar channel.

31. The driving-bar device of claim 25, wherein the plastic material includes at least one of the copolymers polyoxymethylene or polyamide 6.
